(19) United States
(12) Patent Application Publication
(10) Pub. No.: US 2006/0141963 A1
(43) Pub. Date: Jun. 29, 2006

(54) Method and apparatus to reduce the jitter in wideband PLL frequency synthesizers using noise attenuation

(76) Inventors: Adrian Maxim, Austin, TX (US); James Kao, Austin, TX (US)

Correspondence Address: O'KEEFE, EGAN & PETERMAN, L.L.P., Building C, Suite 200, 1101 Capital of Texas Highway South, Austin, TX, 78746, US

(21) Appl. No.: 11/024,025

(22) Filed: Dec. 28, 2004

(51) Int. Cl. H04B 1/18

(52) U.S. Cl. 455/192.1; 455/180.3

(57) ABSTRACT

A noise attenuator loop filter for PLL applications that allows a full on-chip integration of the loop filter capacitors, while ensuring a low output clock phase noise (jitter) is disclosed. A voltage attenuator (A) is inserted between the loop filter (passive or active) and the controlled oscillator. The attenuator attenuates the noise coming from the loop filter. In case of a passive RC filter, the series resistor noise power is attenuated by A² times, allowing the usage of a resistor that is A² times larger and therefore the loop filter capacitors result A² times smaller (easy to integrate on-chip). The relatively low value capacitor allows the usage of thick-oxide accumulation-mode MOSFET capacitors that take a reasonable low area, have a good linearity, are isolated from the substrate by the grounded N-well, and have negligible gate leakage current. Several embodiments of the noise attenuator are proposed for different practical applications: clock generation for digital circuits, frequency translation, low or high supply voltage, narrow or wide frequency range, processes with or without isolated well devices, processes with or without polysilicon resistors, and medium or high reference spurs rejection.

### BACKGROUND OF THE INVENTION

The present invention relates to the field of phase locked loop (PLL) circuits, and more particularly to PLLs utilized in frequency synthesizers for wideband tuner applications, such as for example, satellite, cable, or terrestrial TV tuner applications.

In general, a tuner is an electronic device that receives a high frequency modulated signal (e.g. satellite, cable or terrestrial TV signal) and converts it down to a much lower frequency at which the signal processing is performed. This frequency translation may be accomplished with an electronic block, a mixer, that realizes the above mentioned frequency translation usually by performing a multiplication between the input signal and a locally generated clock signal with variable frequency. The local clock is generated in most cases with frequency synthesizers. A frequency synthesizer is often a circuit block that starts from a high accuracy reference clock frequency (usually from few MHz to tens of MHz) and generates a low jitter and high frequency output clock having a different frequency (typically a variable output frequency that is controlled for example by a digital word). This high frequency clock (often called the local clock) is used by the mixer in the frequency conversion process. In most applications the frequency synthesizer is built with phase locked loop circuits (PLL). A phase locked loop (PLL) is an electronic circuit that typically uses a control feedback loop to tune the frequency and phase of a local oscillator such that the local clock frequency is a multiple (integer or fractional) of the input frequency and the two phases are synchronous (eventually with a small and time invariant phase shift).

In wideband tuner applications (e.g. satellite, cable, or terrestrial TV tuners) the frequency synthesizer used for frequency translation often need to be tuned over a very wide frequency range (GHz). Ring oscillator based PLLs are used in the frequency synthesizer to ensure the wide tuning range at the price of a much larger phase noise in comparison with the LC oscillators based PLLs. To achieve the low output phase noise required by the tuner system level specifications, a large bandwidth PLL generally needs to be used, such that the ring oscillator's high phase noise is adequately rejected.

Integrating both the analog and digital sections of the tuner in a single chip solution has pushed towards deep-submicron CMOS implementations (0.18 um and below). The GHz frequency range, cumulated with the scaling down of the supply voltage with the gate oxide thickness leads to a very large ring oscillator gain. The large PLL loop bandwidth together with the high oscillator gain makes the PLL front-end to be a significant and in some cases the dominant contributor to the output clock total phase noise (jitter). Most frequency synthesizers use a high quality factor crystal oscillator to generate a low phase noise reference frequency. This makes the loop filter a key contributor to the overall phase noise performance, and therefore a prime candidate for improvements towards a low noise implementation.

The most widely used loop filter architecture in low noise PLLs is the passive RC network. Its advantages are: simplicity, high supply noise rejection (as no device in the loop filter is directly connected to the supply line) and no added noise from active components. However for a given loop bandwidth (RC time constant) a low output phase noise requires a low value series resistor (R) and therefore a large value capacitor (C) that in some applications may be too big to be integrated on-chip.

An area efficient way to implement a capacitor on chip is using MOS capacitors. They have a high capacitance per area density and also a fairly good linearity if the device is operated either in strong inversion or accumulation regions. In low reference spur PLLs the charge-pump current is chosen to be low, such that the switch size can be lowered (within a given voltage headroom) and thus minimize the parasitic clock feed-through and channel charge injection.

In deep-submicron CMOS processes the MOS devices come with an ever increasing capacitance density, reducing the required silicon area, but unfortunately this comes at the price of a larger gate leakage current. The leakage current increases sharply with temperature and applied voltage, reaching levels as high as μA or even tens of μA for areas higher that 10,000 μm² (being comparable with the charge-pump current value). If this happens, a significant discharge of the loop filter integration capacitance takes place during each update period, and the PLL loop will react by shifting the feedback clock with respect to the reference clock, such that the average current injected by the charge-pump in each update period compensates the leakage current. This creates a large ripple on the oscillator control signal (voltage or current) and thus results in large reference spurs in the output clock spectrum. The reference spurs are detrimental to the frequency translation PLLs due to the reciprocal mixing effect that can fold unwanted signals (blockers) on top of the wanted signal.

For this reason, often thin oxide MOS capacitors are generally avoided when building the PLL loop filter on-chip capacitors.

One solution to circumvent the leakage current of the loop filter capacitors built in deep submicron CMOS technologies is to use metal-insulator-metal (MIM) capacitors. Such capacitors have a negligible leakage current, a very high linearity of the capacitance-versus-voltage characteristic C(V) and a good isolation from the substrate noise. The last feature is often important in large mixed analog-digital ICs that have a large amount of noise present in the substrate due to the switching action of the digital blocks. The main drawback of MIM capacitors is that they require extra processing steps and therefore increase the processing cost. Another drawback is the relatively large area took by the MIM capacitors, due to their relatively low capacitance density. The MIM capacitors are generally available only in advanced mixed signal CMOS processes, being absent from the standard low cost CMOS processes.

An alternative solution for implementing the loop filter capacitors on-chip is to use the metal interconnect parasitic capacitance. In the present day fine lithography, the lateral distance between two parallel metal lines is significantly smaller than the distance between two adjacent metal layers. This makes the lateral capacitance to be much more effective than the vertical parallel plate capacitance between two layers of interconnect metal. Using highly interleaved metal structures, capacitors in excess of several pF to several tens of pF can be implemented on-chip.

The main advantages of the metal interconnect capacitors are: first of all they can be implemented in all CMOS processes achieving a negligible leakage current, good linearity and if higher level metals are used to build the capacitor, a good isolation from the substrate can be achieved. The drawbacks are the larger required area (comparable with the MIM capacitors) and a poor modeling of the resulting capacitance absolute value. However metal interconnect capacitors have a low process variation (are well reproducible) and they can be accurately characterized with a test chip.

Current deep-submicron CMOS processes usually offer several types of MOS devices including thin oxide MOSFETs for high speed applications and thick oxide (legacy) MOSFETs that are used for input/output circuits that are biased at much higher voltages than the core of the circuit (e.g. 2.5V or 3.3V). In addition to those, low-VT and zero-VT devices may be available in some processes.

The thick oxide devices have negligible gate leakage current and usually come with a capacitance per area density 2-4 times larger than the one of MIM or metal interconnect capacitors. Therefore the thick oxide devices can be used to build the PLL loop filter capacitors. Their drawback is the rather poor isolation from the substrate noise that can be coupled in the PLL loop filter, degrading the output clock jitter performance. The parasitic substrate noise injection becomes particularly troublesome when large area capacitors are used (e.g. 10,000 um2 and higher).

To reduce the substrate noise coupling, the MOS capacitors may be implemented either as accumulation mode capacitors built in grounded n-wells or, in the case of deep n-well CMOS processes, the capacitorrs are realized as inversion mode capacitors sitting in a completely isolated grounded p-well. In the first case the n-well and in the second case the surrounding n-well layer provides an additional layer of isolation from the substrate.

Low jitter PLLs (e.g less than 2 degrees rms phase noise, or correspondingly sub-ps timing jitter for GHz operation frequency) generally require the usage of very low value resistors in the loop filter (1 KOhm or lower). In a standard passive RC filter this results in very large value loop filter capacitors (nF) that cannot be integrated on-chip. Highly integrated applications require fully integrated PLLs with on-chip loop filters. Beside the cost penalty, large loop filter capacitors have also the drawback of an increased parasitic capacitance to the substrate and thus a higher substrate noise sensitivity.

Miller capacitors multiplication was used in the past to decrease the value of the physical capacitor used in the PLL loop filter. Both voltage-mode and current-mode Miller multiplication has been used to implement the large PLL integration capacitor. Voltage-mode Miller multiplication has the drawback of a reduced voltage range at the output of the charge-pump, restricting the output clock frequency range. Current-mode Miller multiplication does not present the voltage headroom problem, but requires a large current in the loop filter, thus being not suitable for portable applications. Miller multiplication reduces by 10-20 times the loop filter capacitance value. However there is a direct relation between the amount of Miller gain and the excess noise injected by the Miller amplifier. In low noise applications the Miller gain is limited to around 5, being much less effective for the on-chip integration of the PLL loop filter. Therefore Miller gained capacitors are used generally in the medium to low end applications, without demanding specifications on the output clock phase noise (jitter).

Another solution to the high gate leakage of the deep submicron MOS capacitors is instead of eliminating it, to compensate its effect. To do this an additional low bandwidth control loop is added, that sets the value of a continuous time current source injected on the loop filter, that compensates the value of the leakage current. This solution is required in the case of standard deep submicron CMOS processes that do not offer thick oxide capacitors and MIM capacitors, and that the imposed area for the design does not allow the usage of the metal interconnect capacitors. The usage of the thin oxide MOS capacitors leads to a very area efficient implementation of the loop filter. Unfortunately, the additional charge-pump used by the leakage current compensation loop degrades the reference spur performance of the output clock. Therefore this architecture may be successfully used in clocking frequency synthesizers for large digital circuits, but may not be recommended in frequency translation synthesizers where large reference spurs degrade the receiver sensitivity due to the reciprocal mixing effect.

Feed-forward architectures have been used to eliminate the stabilizing zero series resistor from the PLL loop filter that is one of the dominant noise contributors in wide frequency range and large bandwidth PLLs. Both voltage-mode and current-mode feed-forward loop filters are currently used depending on the type of controlled oscillator: voltage (VCO) or current controlled (ICO). The active amplifiers (voltage or current) from the feed-forward loop filter contribute additional noise to the system, reducing the benefit of the series resistor elimination. The active loop filter noise is particularly important in PLLs having a low bandwidth (hundreds of KHz or lower) when the 1/f noise plays a significant role.

The gain introduced by the feed-forward path helps to reduce the size of the on-chip capacitance by at least one order of magnitude. To minimize the loop filter noise, passive feed-forward architectures are currently investigated.

In high update frequency PLLs, the loop filter needs to have a negligible time delay in comparison to the update period. Large delays degrade the PLL phase margin and increase the jitter transfer peaking, leading to excess phase noise in the output clock. Ensuring a low delay results in large currents being used in the loop filter active amplifier and therefore more excess noise.

Low cost tuner ICs for the consumer market (for example terrestrial, cable or satellite TV tuners) often require a large level of integration that leads to the integration of the large digital demodulator in the same substrate with the analog RF front-end. The mixed analog-digital nature of the tuner IC may require a very high level of isolation between the two sections of the chip, and also a very high rejection of the substrate noise for the PLL frequency synthesizer. Also a low external components count may be required, leading to the necessity of having a fully integrated low noise frequency synthesizer.

It is therefore desirable to provide a PLL that overcomes some or all of the problems described above in a highly integrated PLL circuit that provides low output clock phase noise (jitter).

### SUMMARY OF THE INVENTION

The present disclosures provides a novel PLL loop filter architecture that utilizes a noise attenuator between the loop filter and the controlled oscillator of the PLL, and that reduces the loop filter noise contribution and the reference and supply injected spurs. The attenuator may be considered to be a separate circuit block between the loop filter, may be implemented as a portion of the loop filter or may be implemented as a portion of the controlled oscillator. In this regard, it will be recognized that the benefits of the attenuation concepts disclosed herein for use in a PLL may be obtained regardless of what portion of the PLL circuit blocks the attenuation circuitry is classified to be contained within.

In one embodiment, there is disclosed a noise attenuator for PLL applications that allows a full on-chip integration of the loop filter capacitors, while ensuring a low output clock phase noise (jitter). In such an embodiment, an attenuator that attenuates the noise coming from the loop filter may be placed between (or within either of) the loop filter (passive or active) and the controlled oscillator. The attenuator in one embodiment may be a voltage attenuator having an attenuation of A. In case of a passive RC loop filter, the series resistor noise power is attenuated by A² times, allowing the usage of a resistor that is A² times larger and therefore the loop filter capacitors result A² times smaller (thus easier to integrate on-chip). The relatively low value capacitor allows the usage of thick-oxide accumulation-mode MOSFET capacitors that take a reasonable low area, have a good linearity, may be isolated from the substrate by a grounded n-well, and have negligible gate leakage current. Many different embodiments of the noise attenuator may be utilized. The noise attenuator may be utilized in many different practical applications: clock generation for digital circuits, frequency translation, low or high supply voltage applications, narrow or wide frequency range applications, processes with or without isolated well devices, processes with or without polysilicon resistors, and applications requiring medium or high reference spurs rejection.

In one embodiment, a phase locked loop circuit is provided. The phase locked loop circuit may include a controllable oscillator providing an oscillator output, a loop filter coupled within a loop path of the phase locked loop and an attenuator located within the loop path. The attenuator may be located between at least a portion of the loop filter and an input of the controllable oscillator. The attenuator reduces phase noise in a clock provided at the oscillator output.

In another embodiment, a phase locked loop based frequency synthesizer for use in wideband tuner applications is provided. The circuit may comprise a controllable oscillator, a loop filter, and a voltage attenuator. The voltage attenuator may be placed within a loop path of the phase locked loop and be located between the controllable oscillator and at least a portion of the loop filter. The voltage attenuator may comprise an input buffer and a voltage divider.

In still another embodiment a method of integrating a frequency synthesizer circuit within an integrated circuit to provide a low phase noise output clock is disclosed. The method may include providing a phase locked loop, providing a controllable oscillator within the phase locked loop and providing a loop filter within the phase locked loop, the loop filter including at least one loop filter capacitor within the integrated circuit. The method further comprises attenuating a control input signal to the controllable oscillator sufficiently to allow for a smaller loop filter capacitor to be utilized as compared to the size that is required without such attenuation while still providing the same or better phase noise characteristics.

### BRIEF DESCRIPTION OF DRAWINGS

FIG. 1 illustrates a prior art PLL circuit.

FIG. 1b illustrates one embodiment of a PLL utilizing the concepts disclosed herein.

FIGS. 2a and 2b illustrate attenuators utilizing a resistor divider.

FIGS. 3a-3d illustrate attenuators utilizing a resistor divider and a source follower configuration.

FIGS. 4a-4b illustrate attenuators which have reduced substrate noise injection.

FIGS. 5a-5b illustrate attenuators with reduced supply injected noise.

FIGS. 6a-6d illustrate several types of supply line filters and regulator that may be coupled to a loop filter and attenuator.

FIG. 7 illustrates the use of a supply voltage booster to increase the attenuation factor.

FIGS. 8a-8d illustrate transconductance based attenuators.

FIGS. 9a-9g illustrate common source attenuation stages.

FIGS. 10a-10f illustrate all pass capacitor divider attenuators.

FIG. 11 illustrates a passive feed forward loop filter with a resistor divider attenuator.

### DESCRIPTION OF THE PREFERRED EMBODIMENTS

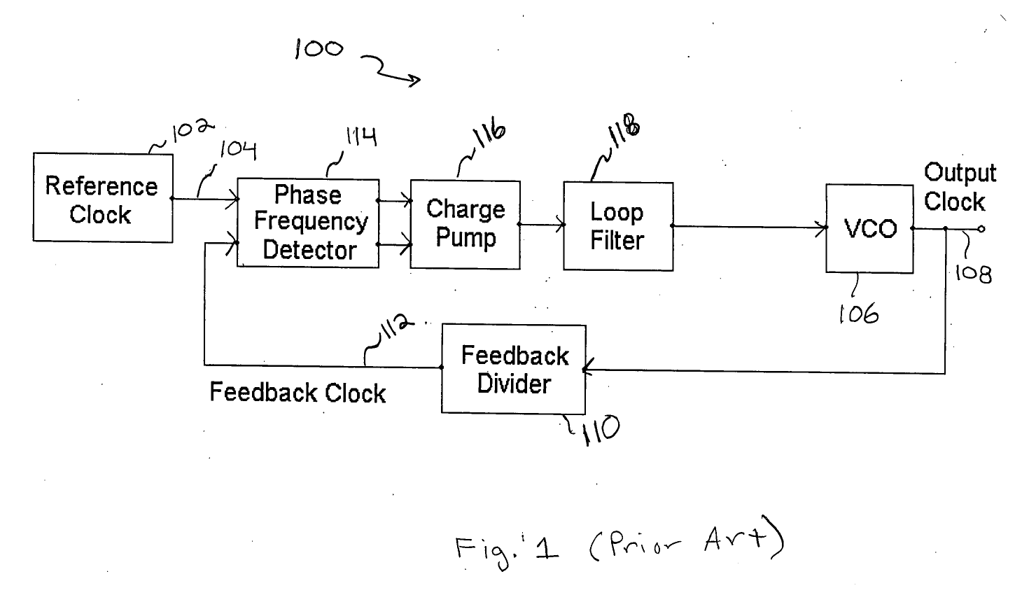

As will be recognized by those skilled in the art, a general block diagram of a typical prior art phase locked loop (PLL) circuit 100 is shown in FIG. 1. The PLL 100 includes a reference source 102 that provides a stable, low frequency reference clock 104. The reference source 100 may be integrated with the PLL or may be a clock source separate from the PLL 100. The PLL 100 also includes a local controlled oscillator (LO) 106 that generates the high frequency output clock 108. The local controlled oscillator 106 is typically either a voltage controlled oscillator (VCO) or a current controlled oscillator (ICO). The output clock 108 is also provided to a feedback divider 110 (which may be a digital divider) that divides down the output clock 108 and provides a feedback clock 112 that is compared in frequency and phase with the reference clock by the phase-frequency detector (PFD) 114. The output of the PFD 114 may be provided to a charge pump 116 which in turn provides an output to a loop filter 118. The loop filter provides a control signal to the local controlled oscillator 106 and ensures the stability of the feedback control loop and reduces the ripple on the oscillator control signal, helping thus the reduction of the output clock jitter and reference spurs. It will be recognized by those skilled in the art that many variations for each of the circuit blocks shown in FIG. 1 may be utilized and the inventions disclosed herein are not limited to any particular type or configuration of the basic PLL circuit blocks.

The quality of the output clock 108 is generally measured in terms of phase noise, time jitter and spurs. The main contributions to the total phase noise of the output clock come on one side from the local oscillator (LO) and on the other side from the PLL front-end (the loop filter 118 being the dominant contributor). Depending on the loop bandwidth and feedback divider modulus, the phase noise of the reference crystal clock (that is multiplied by the square of the feedback divider modulus when expressed in power) may become also a significant contributor to the output clock phase noise.

The different noise contributors are seeing different frequency domain transfer functions. The reference clock noise is low-passed filtered, the loop filter noise is band-passed filtered, while the oscillator phase noise is high-passed filtered when reflected to the output of the PLL. The corner frequency of all these three transfer functions is the natural frequency of the PLL, that is directly related to the PLL loop bandwidth. An optimal compromise between the local oscillator and the reference oscillator phase noise contributions is achieved by choosing the PLL bandwidth around the point where the LO phase noise power spectrum crosses the gained-up output reflected PLL front-end phase noise power spectrum.

Covering a large frequency range (GHz) while using an headroom constrained control voltage (e.g. Vctrl<1.3V for typical 0.13 um CMOS designs) leads to a very high oscillator gain. This increases the noise contribution of the loop filter, making it in many cases the dominant contributor. Furthermore the large oscillator gain degrades the output clock reference spurs caused by the finite ripple on the oscillator control voltage generated by the phase-frequency detector and charge-pump mismatches and asymmetries.

In the case of a passive RC loop filter, lowering its noise contribution requires the usage of a very low value series resistor (1 Kohm or lower). For a given RC time constant required by the PLL loop bandwidth, an unreasonable large capacitor value results (several nF or even higher) that is hard to integrate on-chip.

FIG. 1a illustrates one embodiment of a PLL 150 according to the present disclosure. As shown in FIG. 1a, the PLL 150 may be similar to prior art PLL structures except with the inclusion of a noise attenuator circuit block 152 between the loop filter 118 and the local controlled oscillator 106. It will be recognized that the noise attenuator circuit block 152 may be construed as a separate circuit block that receives the output of the loop filter 118 and that the output of the noise attenuator circuit block 152 provides a control signal that is an input of the controlled oscillator 106. Alternatively, the noise attenuator circuit block may be construed as part of the circuitry that forms the loop filter 118 or part of the circuitry that forms the local controlled oscillator 106. Thus, the concepts disclosed herein may be achieved whether the PLL circuitry is considered to have a segmented circuit block that operates as the noise attenuator circuit block or the circuitry is combined within one of the other PLL circuit blocks. Moreover, the functionality of the noise attenuator circuit block need not be formed as merely a back-end portion of the loop filter block or a front-end portion of the local controlled oscillator, but rather may be embedded within the circuitry of such circuit blocks. It will also be recognized by those skilled in the art that many variations may be utilized for each of the circuit blocks shown in FIG. 1a that are in common with the prior art PLL of FIG. 1. Thus, the inventions disclosed herein are not meant to be limited to any particular type or configuration of the basic PLL circuit blocks such as the clock source 102, the PFD 114, the charge pump 116, the loop filter 118, the local controlled oscillator 106 and the feedback divider 110.

The use of a noise attenuator circuit block 152 will attenuate the noise contribution of both the loop filter and the PLL front-end. For example, if the noise attenuator circuit block 152 is a voltage attenuator and if the voltage attenuation factor is “A”, it may be shown that for the same budget of the output clock phase noise the loop filter resistor can be increased by a factor of A², while the loop filter capacitor can be decreased by a factor of A². Therefore the required on-chip capacitance decreases from the nF range in the standard RC loop filter to hundreds of pF for the noise attenuator loop filter. This will allow the on-chip integration of the loop filter, leading to a fully integrated frequency synthesizer and a minimized count for the external components.

a. Attenuator Classification

Attenuators can be built in a wide variety of manners and the concepts disclosed herein be implemented using many different types of attenuators. It will be recognized to those skilled in the art that the attenuators shown herein are exemplary and other attenuators may be utilized will still obtaining the benefits of the techniques disclosed herein. Generally attenuators may be classified as having either passive or active circuits (or a combination of both). In the context of usuge in a PLL, desirable attenuators may satisfy (but are not required to) the following conditions: have an attenuation type transfer function with a fixed attenuation factor from DC up to the main ripple pole of the PLL loop, and contribute negligible noise in comparison with the main noise sources from the PLL loop (oscillator, loop filter and reference clock).

Resistor dividers or capacitor dividers are typical utilized for passive attenuators. The first one can be realized using polysilicon resistors (if they are available in the considered semiconductor IC fabrication process), or using active simulated resistances generated with the transconductance (gm) of transistors (if good quality passive resistors are not available). To avoid the loading of the loop filter by the resistor divider, an isolation element or buffer stage may be desirable. The most common implementations of the isolation element or buffer stage are either the source (or emitter in bipolar implementations) follower or the common source (emitter in bipolar implementations) stages. This implementations present a very high input impedance in the gate that has primarily a capacitive nature. The extremely low gate leakage current prevents the discharge of the loop filter integral capacitance and thus help achieving good reference spurs rejection.

The source follower buffer has the advantage of impedance transformation, showing a very high input impedance to the loop filter and a relatively low output impedance towards the resistive divider. This avoids the signal loss on the non-ideal input and output impedances of the buffer stage.

An alternate way of realizing the attenuator is using a common-source buffer having a sub-unitary gain (G<1). Polysilicon resistors can be connected to its source and drain to stabilize the gain at the corresponding resistor ratio. In processes where polysilicon resistors are not available a diode connected transconductance (gm) can be used as load in the drain, while the source of the gain device is directly connected to ground. The gain will result a ratio of transconductances that track well over process and temperature.

Capacitor dividers that are used for attenuators can use any of the capacitor types available in a given process, including: metal-insulator-metal (MIM) capacitors, metal interconnect capacitors, inversion or accumulation-mode MOS capacitors, etc. From the different choices available it may be preferred to select the one that has the minimum parasitic capacitance to the substrate, as this will give a better isolation from the large substrate noise present in mixed analog-digital ICs. The lowest substrate parasitic capacitance is often achieved by the MIM capacitors, than the metal interconnect capacitors, followed by the accumulation-mode MOS capacitors, and finally the worst ones are typically the standard inversion-mode capacitors that are built directly in the substrate. If the signal path is referred to the positive supply, PFET inversion-mode capacitors can be used, as they are built in an isolated N-well, having a smaller parasitic coupling to the substrate. In the twin well CMOS processes or the deep n-well CMOS processes, also the NFET inversion-mode capacitors can be built in isolated p-wells, having a good isolation from the substrate.

As discussed in more detail below, capacitive dividers may need a high value resistor divider connected in parallel in order to ensure the desired attenuation factor at DC and low frequencies.

In the following paragraphs there will be described several attenuator embodiments using passive and active architectures. It will be recognized, however, that the concepts disclosed herein are not limited to these particular architectures.

b. Resistor Divider Attenuator

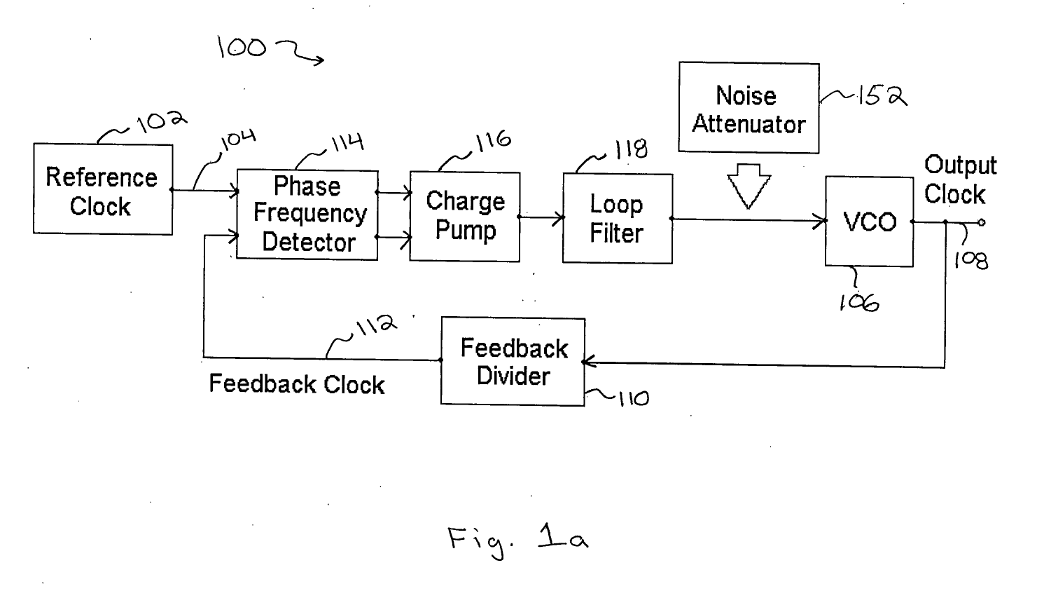

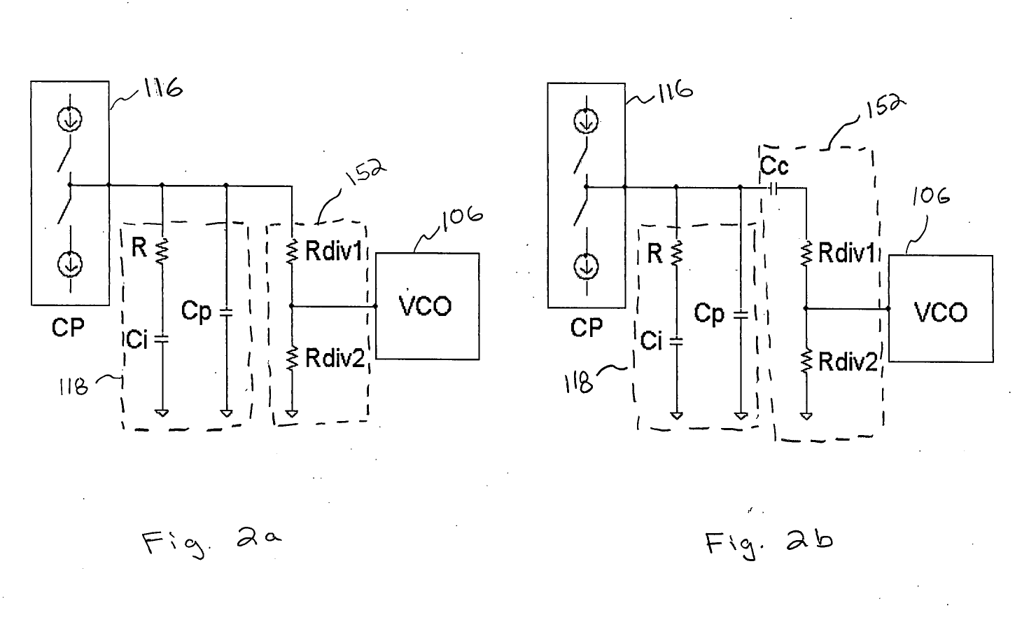

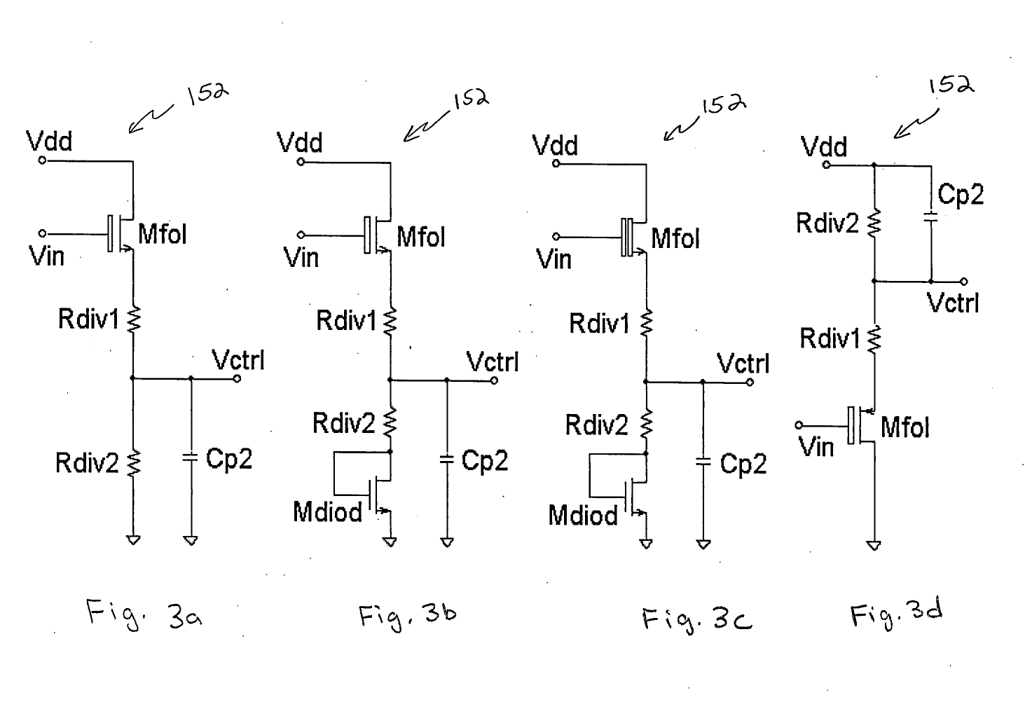

A simple resistor divider attenuator architecture is shown in FIGS. 2a and 2b. It will be recognized that FIGS. 2a and 2b illustrate only a portion of a PLL but that the circuitry shown may be included in a PLL such as shown in FIG. 1a. FIGS. 2a and 2b include a charge pump 116, a loop filter 118, an attenuator 152, and an oscillator 106. The attenuator 152 is shown as a separate circuit block in these figures, however, as described above the attenuator could be construed to be a portion of other circuit blocks of the PLL. Thus, for example, the loop filter 118 circuit block and the attenuator 152 circuit block could be re-characterized as a single circuit block (for example characterized as a single attenuating loop filter circuit block). For ease of understanding this concept, when specific circuit components of the loop filter and attenuator circuit blocks are shown in the figures herein, separate blocks denoting the boundries of each block will not be shown (it will be recognized that this could similarly apply to inclusion of attenuation elements in the controlled oscillator 106).

The loop filter 118 may be formed in any of a wide variety of manners as is will be recognized by those skilled in the art. One technique for forming a loop filter is shown in FIGS. 2a and 2b. The techniques described herein, however, do not require the use of any particular loop filter. As shown in FIGS. 2a and 2b the loop filter 118 may be a passive filter comprised of a resistor R, an integration capacitor Ci and a ripple pole capacitor Cp (which provides a main filtering pole), however, other types of loop filter architectures may be utilized.

The simplest way to build a voltage attenuator is using a resistor divider such as for example, utilizing resistors Rdiv1 and Rdiv2 as shown in FIG. 2a. However, it is not desirable to directly connect such a divider in parallel with the passive RC filter (as was done in FIG. 2a), because of the large leakage current in the resistor chain that will discharge the integrating capacitance during every update period. For low noise impact of the resistor divider, it is desirable that Rdiv1 and Rdiv2 have low values and thus lead to a large discharge current. The PLL loop will react to this discharge by shifting the phase of the feedback clock from the reference clock, such that the current injected by the charge-pump will compensate during each update period the leakage current. A large ripple appears on the oscillator control voltage that will generate large unwanted reference spurs in the output clock frequency spectrum.

From the open loop PLL analysis standpoint, the resistor divider shifts away from the origin (fp=0) the pole introduced by the charge-pump and the integrating capacitance. This will change the type II nature of the PLL into a type I behavior, leading to a large phase difference between the feedback and the reference clocks (degraded output clock jitter).

An alternative way of coupling the resistor divider formed by resistors Rdiv1 and Rdiv2 to the loop filter is using a coupling capacitance Cc as shown in FIG. 2b. This minimizes the leakage current problem, avoiding the integral capacitance discharge. However the coupling capacitor Cc may introduce a zero at the origin (fz=0) that will cancel one of the two poles at the origin (fp=0) of the standard charge-pump PLL architecture. As a result the PLL will be converted from a type II to a type I configuration, possibly bringing a degraded jitter and reference spurs performance.

The type I PLLs are generally not suited for the frequency translation applications due to their high reciprocal mixing effect. However they may be acceptable for the digital clock generation applications where the timing jitter caused by the random noise in the oscillator and the loop filter is by far larger than the jitter resulted from the boosted reference spurs.

One solution to couple the resistor divider to the loop filter without discharging the integral capacitor and also without converting the loop into a type I configuration is to use a high input impedance and a low output impedance buffer stage. A good candidate for this type of impedance converter buffer is the source follower in CMOS processes (emitter followers in the bipolar implementations). The high input impedance at the gate of such a buffer avoids the discharge of the integral capacitance, while its low output impedance prevents the noise degradation due to the active device (large area devices generally are desirable such that the channel thermal noise is the dominant noise coming from the device, while the 1/f noise component is negligible).

FIG. 3.a presents another embodiment of an attenuator 152. As shown in FIGS. 3a-3d, the attenuator 152 may receive an input Vin from a loop filter (not shown) and provide an output Vout which may be used as the control input to the controlled oscillator (not shown). The embodiment of the attenuator 152 shown in FIGS. 3a-3d may comprise a resistor divider built with resistors Rdiv1 and Rdiv2 that provides the required attenuation factor, a source follower transistor (Mfol) that isolates the leaky resistor divider from the loop filter integration capacitance, and a capacitor Cp2 that together with the output impedance of the divider Rout=Rdiv1//Rdiv2 provides a second ripple filtering pole to the loop. Such a circuit helps both improving the reference spurs performance and rejects the high frequency noise. The source follower configuration eliminates the discharge of the integral capacitance and preserves the type II nature of the loop, with a negligible small phase shift between reference and feedback clocks (depending only on phase-frequency detector and charge-pump mismatches).

The voltage gain (G), the corresponding voltage attenuation (A) and the output impedance of the noise attenuator are given by the following expressions:

$$\begin{matrix}G = \frac{1}{A} = \frac{{R}_{div 2}}{{R}_{div 1} + {R}_{div 2} + 1 / gm ( {M}_{fol} )} < 1 & ( 1 ) \\ {R}_{out} = {R}_{div 2} // ( {R}_{div 1} + 1 / {g}_{m} ( {M}_{fol} ) ) \approx {R}_{div 2} // {R}_{div 1} & ( 2 )\end{matrix}$$

The first and the second ripple poles of the PLL in open-loop are given by:

$${f}_{p 1} = \frac{1}{2 π \cdot R \cdot {C}_{p}} ; {f}_{p 2} = \frac{1}{2 π \cdot {R}_{out} \cdot {C}_{p 2}} \qquad ( 3 )$$

The second pole is generally selected to be higher than the first ripple pole, such that it does not impact the PLL phase margin (stability), but helps the high frequency noise attenuation.

Large area devices generally should be used for transistor Mfol such that the 1/f noise becomes negligible in comparison to the thermal noise of the resistor divider. Also, it may be desirable to utilize longer than minimum length (e.g. 0.25 um in 0.13 um CMOS process) transistors for the source follower in order to minimize the excess thermal noise. With these assumptions the thermal noise voltages of the noise attenuator components are given by:

$${v}_{n}^{2} ( {R}_{div 1} ) = 4 kT \cdot {R}_{div 1} ; {v}_{n}^{2} ( {R}_{div 1} ) = 4 kT \cdot {R}_{div 1} ; {v}_{n}^{2} ( {M}_{fol} ) = 4 kT \cdot \frac{2}{3} \cdot \frac{1}{{g}_{m} ( {M}_{fol} )} \qquad ( 4 )$$

It can be observed that for the large area and long channel MOS devices for which the 1/f and excess thermal noise component is negligible, its intrinsic noise can be comparable or even smaller than the thermal noise of an equivalent physical resistor. The loop filter operates at low frequencies (usually tens of MHz) where the excess gate noise is negligible.

The noise coming from the stabilizing zero resistance of the passive RC loop filter is attenuated by the square of attenuation factor:

$${v}_{n\_out}^{2} ( R ) = {v}_{n}^{2} ( R ) \cdot {G}^{2} = \frac{{v}_{n}^{2} ( R )}{{A}^{2}} = 4 kT \cdot \frac{R}{{A}^{2}} \qquad ( 5 )$$

From the loop filter output noise perspective the resistor R appears attenuated by A² times. This means that for a given phase noise (jitter budget), a resistor A² times larger than the one from the standard RC loop filter can be used. As a consequence the required capacitor value is A² smaller, being easier to integrate on-chip and also having a much smaller parasitic coupling capacitance to the substrate.

The polysilicon resistors and the transconductance of the source follower transistor do not track well over process and temperature. As a result a noticeable variation of the attenuation factor and of the output impedance may appear over process and temperature. Furthermore the control voltage for the oscillator varies over a range that has a large offset voltage (Voff; Voff+ΔV). For many oscillators the control voltage also sets the amplitude of oscillation, which needs to be kept high such that a low phase noise results. Generating the entire control voltage with an IR voltage drop leads to a large current in the attenuator, that may not be compatible with many portable applications. FIG. 3.b presents a second embodiment of the loop filter noise attenuator in which an additional diode connected NFET Mdiod is added in the bottom leg of the divider. The transistor Mfol and diode Mdiod operate at the same current level and are in close proximity, such that they operate at the same temperature. In the cases when the control voltage is larger than 0.8V both devices can be thick oxide FETs and therefore they match well over process. The gain (G) of this attenuator is given by:

$$G = \frac{1}{A} = \frac{Rdiv 2 + \frac{1}{gm ( Mdiod )}}{Rdiv 1 + \frac{1}{gm ( Mfol )} + Rdiv 2 + \frac{1}{gm ( Mdiod )}} \qquad ( 6 )$$

To achieve a process and temperature independent attenuation factor (A), the ratio of the two transconductances needs to be selected equal to the ratio of the two resistors:

$$\frac{Rdiv 2}{Rdiv 1} = \frac{gm ( Mfol )}{gm ( Mdiod )} \qquad ( 7 )$$

Maintaining a process and temperature independent attenuation factor helps reduce the process and temperature variation of the loop gain and loop damping factor.

Large area devices are desirable for both transistor Mfol and diode Mdiod such that their 1/f noise becomes negligible in comparison with the thermal noise of the resistor divider. Also longer than minimum lengths (e.g. 0.251 μm, 0.5 μm or even 1 μm in a 0.13 μm) are desirable for the two devices such that the excess thermal noise due to short channel effects is eliminated.

Approximating the noise of a MOSFET with the thermal noise of its equivalent resistance (upper bound for large area and long channel devices) the noise contribution of the attenuator will be given by the thermal noise of the output impedance (the active divider can be approximated with a passive divider from the noise stand point):

$$\begin{matrix}{v}_{n\_out}^{2} ( attenuator ) = 4 kTRout \\ Rout = ( Rdiv 1 + \frac{1}{gm ( Mfol )} ) // ( Rdiv 2 + \frac{1}{gm ( Mdiod )} ) & ( 8 ) \\ Rdiv 2 = G \cdot Rdiv 1 = Rdiv 1 / A \\ gm ( Mdiod ) = A \cdot gm ( Mfol ) & ( 9 ) \\ ⇒ Rout = \frac{1}{1 + A} ( Rdiv 2 + \frac{1}{gm ( Mdiod )} ) << R & ( 10 )\end{matrix}$$

The transconductances of transistor Mfol and diode Mdiod depend on the current though the divider (ID). This current is given by the necessary control voltage for the oscillator (Vctrl) to get to a given output frequency, the VTh threshold voltage of the FETs and the value of the resistors Rdiv1 and Rdiv2. To keep a low noise contribution of the two active devices their gm should generally be kept high, which leads to a large current through the divider. The advantage of using small 1/gm and large Rdiv resistors is that the current through the divider varies over a small range, being constrained by the resistors Rdiv1 and Rdiv2. The noise contribution of the divider resistors and active devices is designed to be negligible in comparison with the noise coming from the series resistor of the loop filter (at least a factor of 4 smaller in power).

Having transistor Mfol and diode Mdiod matched in type gives a process independence of the attenuator gain. However this comes at the price of a wider voltage range at the output of the charge-pump, and thus a lower achievable attenuation factor. Furthermore this restricts the minimum control voltage for the oscillator to 0.7-0.8V, reducing the frequency tuning range. If lower control voltages need to be achieved, the transistor Mdiod may need to be a thin oxide NFET, even if this will give a slight variation of the attenuation factor over process and temperature.

When using regular threshold voltage FETs for both Mfol and Mdiod the voltage at the charge-pump output becomes Vcp=A*Vctrl. It is desirable for the control voltage for the oscillator to be kept as high as possible (limited by the device breakdown) to ensure a low phase noise in the ring oscillator. For a 0.13 um CMOS this maximum control voltage is generally around 1.3V. Considering at least 0.4V headroom for the charge-pump current mirrors and using a minimum supply voltage of 3V, a maximum 2.6V can be used for Vcp. This limits the achievable attenuation factor to A=2. This gives an attenuation of a factor 4 of the loop filter capacitor value.

FIG. 3.c presents a third embodiment of the loop filter noise attenuator that boosts the attenuation factor by using a zero-Vt thick oxide NFET as source follower. In doing so the voltage range at the output of the charge-pump is reduced by a Vth threshold voltage for thick oxide devices (0.7-0.8V), allowing a maximum attenuation factor of 2.5 for a minimum supply voltage of 3V. As will be recognized by those skilled in the art, the embodiments shown herein are not limited to the particular device types (NFET or PFET) shown. For example, FIG. 3d illustrates a PFET version of the circuitry of FIG. 3a.

If the supply voltage has significant noise a regulator may need to be used, reducing the available headroom and thus constraining the maximum attenuation factor. It may be desirable therefore to use circuit solutions that can provide a larger value for the attenuation factor and thus a more substantial reduction of the loop filter on-chip capacitance.

c. Cascoded Source Follower Attenuator for Reduced Substrate Noise Injection

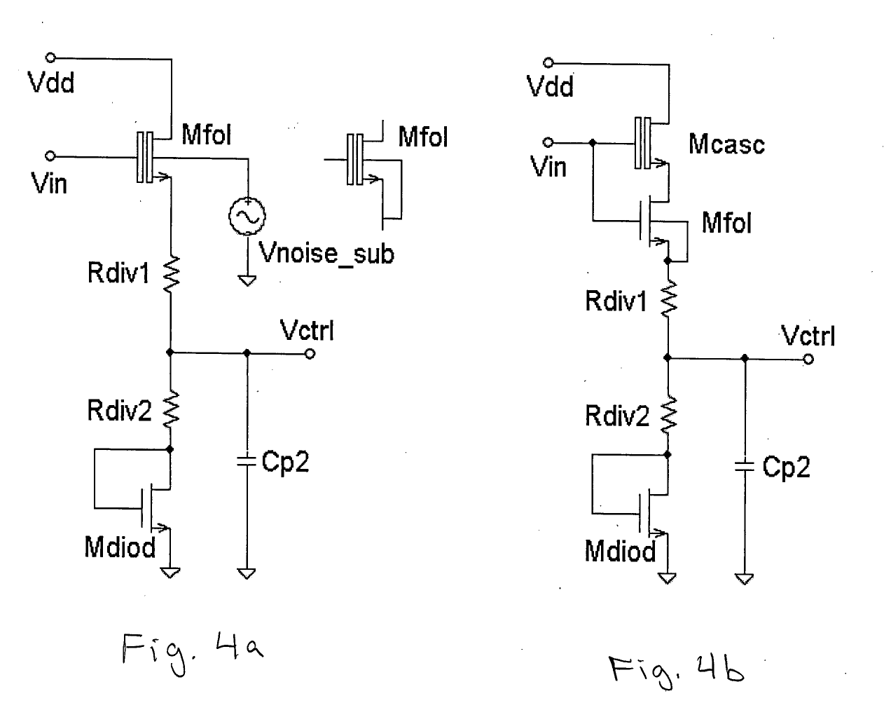

Large mixed analog-digital ICs are often characterized by a high value of substrate noise caused by the switching in the digital section of the IC. Thus, the circuit of FIG. 3a may be characterized as having a noise component Vnoise_sub as shown in FIG. 4a. However, In deep-submicron MOSFETs the ratio between the gate transconductance (gm) and the bulk (back gate) transcondcutance (gmb) is rather small (3-15 depending on the device size), leading to a low value for the substrate noise rejection ratio of the source follower transistor (Mfol) in the case that its bulk is connected directly to the substrate (see alternative transistor Mfol connection as shown in FIG. 4.a).

Reducing the substrate noise injection can be achieved by using FETs built in isolated p-wells that are separated from the P-substrate by a deep n-well underneath the p-well and by regular n-wells on the lateral sides of the p-wells. Having the device in an isolated well allows the connection of the body to the source and thus eliminates the body effect. On one side the threshold voltage will be lower, reducing the voltage headroom constraints in the circuit and on the other side the gain of the substrate noise through gmb is zeroed-out. A lower VT for the follower leads to a larger voltage range at the output of the charge-pump, and thus to a higher value of the attenuation factor, with beneficial effect on the on-chip loop filter size reduction.

In some processes the bulk of the NFETs cannot be connected to the source because the device cannot be built in an isolated well. Such examples are the NFETs in p-substrate CMOS processes that do not have a deep n-well, or the zero-VT (native) devices in most CMOS processes as the native doping cannot be achieved in a p-well grown on top of the deep n-well. The zero-VT devices are largely used in headroom constrained designs and therefore it is desirable to use a circuit that accounts for their high substrate noise sensitivity.

FIG. 4.b presents another embodiment of the noise attenuator that uses a thick oxide zero-VT NFET for protection purposes, transistor Mcasc, while the active signal path follower is built with a thin oxide device transistor Mfol that has its bulk connected to the source. In this way the native device that has its bulk connected directly to the global substrate is a cascade device and thus has a much higher substrate rejection ratio.

The thin oxide device Mfol has no body effect and as a result its threshold voltage is relatively low (Vt=0.3-0.4V) and does not reduce significantly the voltage headroom at the output of the charge-pump. However its gate voltage can reach values that are higher than the breakdown voltage of the thin oxide FETs. The bulk to source connection helps avoid any breakdown issues as the gate to channel voltage is kept low.

Thin oxide devices may suffer from large gate leakage currents that may degrade the reference spurs performance. To minimize the gate leakage the VDS voltage may be kept low and a low area device may be used. The advantage of thin oxide devices is that they can achieve a large transconductance (gm) even within a small device area.

d. Use Regulators to Reduce the Supply Injected Noise

Aside from the reference spurs generated by the switching of the charge-pump (reference spurs) the supply injected spurs are also of great interest for low jitter PLLs. A particular concern is the supply noise that has significant power around the PLL loop bandwidth, where the frequency synthesizer is more sensitive. Thus, as shown in FIG. 5a, a noise component Vdd_noise may be considered to be present.

Using an active FET follower to isolate the voltage attenuator from the passive RC filter introduces a parasitic coupling path from the supply line to the control voltage for the oscillator through the gate-drain capacitance of the follower such as shown by capacitance Cgd of FIG. 5a. The supply noise rejection ratio (PSRR) is dependent on the ratio between the impedance of the RC loop filter and the equivalent impedance of the capacitance Cgd.

$${V}_{sup\_noise} = \frac{{Z}_{LF} ( f )}{{Z}_{LF} ( f ) + \frac{1}{ω \cdot {C}_{GD}}} \qquad ( 11 )$$

The noise rejection ratio value varies with frequency. At low frequencies (f<fz lower than the stabilizing zero) the loop filter impedance is dominated by the integral capacitor (Ci), for frequencies between the stabilizing zero and the ripple pole (fz<f<fp) the loop filter impedance is dominated by the series resistance (R), while at high frequencies (f>fp larger than the ripple pole frequency) the loop filter impedance is dominated by the ripple pole capacitance (Cp). The supply noise injected voltage for the three frequency ranges is given by the following approximate equations:

$$\begin{matrix}for f < {f}_{z} \to {V}_{sup\_noise} = \frac{\frac{1}{ω \cdot {C}_{i}}}{\frac{1}{ω \cdot {C}_{i}} + \frac{1}{ω \cdot {C}_{GD}}} = \frac{{C}_{GD}}{{C}_{i} + {C}_{GD}} & ( 12 ) \\ for {f}_{z} < f < {f}_{p} \to {V}_{sup\_noise} = \frac{R}{/ R + \frac{1}{jω \cdot {C}_{GD}} /} & ( 13 ) \\ for f > {f}_{p} \to {V}_{sup\_noise} = \frac{\frac{1}{ω \cdot {C}_{p}}}{\frac{1}{ω \cdot {C}_{p}} + \frac{1}{ω \cdot {C}_{GD}}} = \frac{{C}_{GD}}{{C}_{p} + {C}_{GD}} & ( 14 )\end{matrix}$$

To compute the overall supply noise rejection one need to apply the feedback loop theory and consider Vsup_noise as the input voltage to the system. The transfer function from the voltage on the RC passive filter to the output clock phase noise is a band-pass characteristic having the center frequency around the natural frequency of the loop. At low frequencies (f<fz) and high frequencies (f>fp) an additional rejection is added by the band-pass transfer function of the PLL. Therefore from the supply noise perspective the most sensitive frequency range is around the loop natural frequency.

To minimize the supply injected spurs, it is desirable to minimize the parasitic capacitance Cgd of the source follower. This implies the usage of lower channel width (W) and thus a larger Vgs voltage drop for the transistor Mfol. This reduces the voltage headroom at the output of the charge-pump and thus limits the maximum value achievable for the attenuation factor. It can be seen that a compromise is desirable between output clock random jitter that requires a larger attenuation factor (A) and the supply injected noise rejection that requires a lower parasitic capacitance Cgd that comes with a reduced value of the attenuation factor (A).

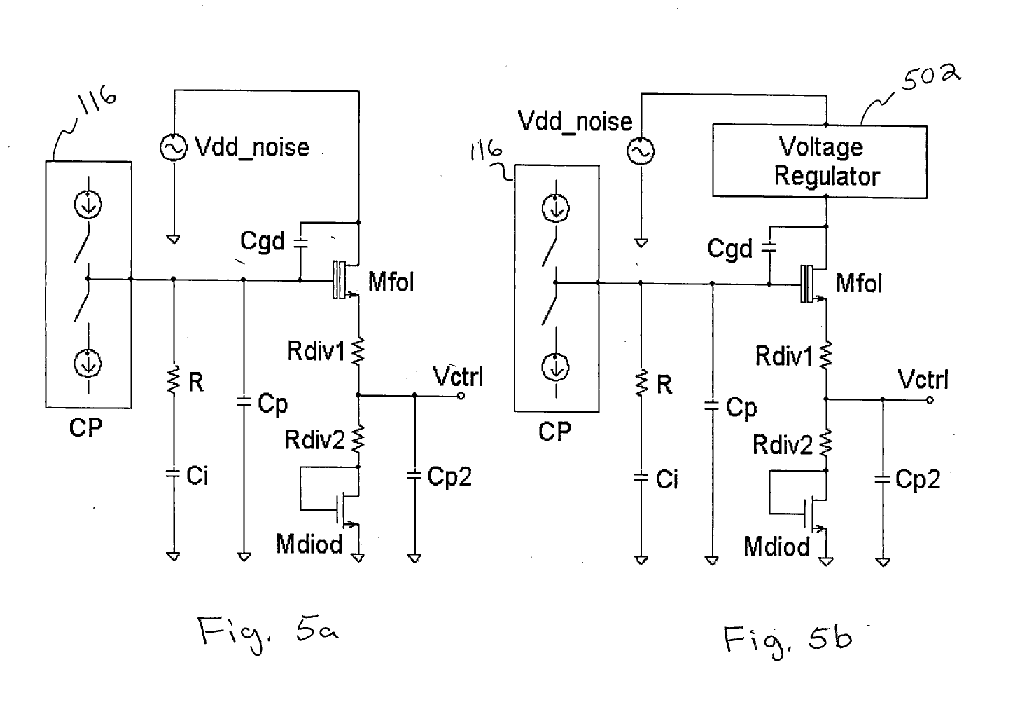

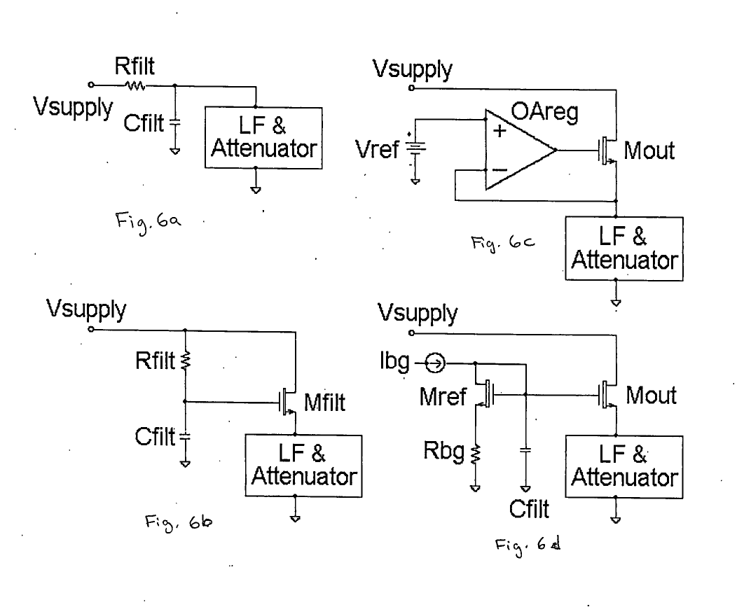

Another solution to reduce the supply injected spurs is to introduce a filter or a voltage regulator between the supply line and the drain of the source follower as shown in FIGS. 6a-6d. If the bandwidth of the PLL (natural frequency) is large (MHz range) a simple passive RC filter can be introduced in the supply path of the attenuator as shown in FIG. 6a. The limited available voltage headroom constrains the series resistance Rfilt to several tenths to few hundred Ohms. To get at least 20 dB attenuation of the supply ripple around the loop natural frequency, the corner frequency of the RC filter need to be one decade lower (several tenths of KHz to few hundreds of KHz). Therefore a large filtering capacitance Cfilt is required.

FIG. 6b presents an active RC filter that uses a zero-threshold voltage FET Mfilt to provide the load current. The gate resistor has no DC current and can be selected with a large value (hundreds of KOhms). This will reduce the amount of on-chip capacitance required for the supply line filtering by at least three orders of magnitude. The voltage drop on this active RC filter is VDS=VGS=Vth+Von≈Von is essentially equal to the overdrive voltage of the zero-VT FET. Low Von voltages require large W/L ratios. Using minimum L allowed by the process, large W/L result in large channel widths W. The increased CGD parasitic capacitance of the supply follower degrades the amount of supply noise rejection at high frequencies. After the corner frequency of the RC filter, the supply rejection is given by the ratio between the CGD and Cfilt capacitors. This type of active RC filter is worth using only if zero-Vt devices are available. Otherwise the large VT voltage gives about 1V voltage drop on the filter and limits drastically the maximum achievable attenuation factor.

If the PLL natural frequency is low (few hundreds of KHz or even lower down to the tens of KHz) the amount of filtering capacitance required by the passive or active RC filter is too large to be efficiently implemented on-chip. In this case it is advantageous to use a voltage regulator to reduce the amount of supply ripple at the drain of the attenuator's source follower. As long as the voltage drop on the regulator is comparable with the headroom constraint on the charge-pump required to keep the current sources in active region, the regulator will not reduce the maximum achievable attenuation factor (a zero-Vt FET source follower was assumed). FIG. 5b illustrates the use of a voltage regulator 502 coupled between the supply line and the drain of transistor Mfol.

Closed loop regulators (see FIG. 6c) achieve a very good supply noise rejection ratio at low frequencies, but their rejection performance drops fast outside the feedback loop bandwidth. This solution is optimum in the cases when the power spectrum of the noise on the supply line is concentrated at low frequencies.

To achieve a good PSRR both at low and high frequencies an open loop regulator may be used (see FIG. 6d). The drawback is the large process variation of the output regulated voltage that will further constrain the attenuator headroom and thus will reduce somewhat the achievable value of the attenuation factor. Again, a compromise is desirable between the random noise rejection (large A) and the supply noise rejection (that leads to a reduced A). Another drawback of the open loop regulators is their relatively large output impedance. Therefore they can tolerate only almost DC load currents. If the load current has a significant AC component, it will modulate the regulated voltage and this ripple can couple back into the loop filter. The only AC current in the loop filter attenuator is generated (in lock conditions) by the charge-pump current mismatch injected into the RC loop filter network. To reduce the AC current in the source follower the mismatch between the pump-up and pump-down charge-pump currents should be minimized and also the dead-zone avoidance up/down pulses should be reduced in duration.

e. Use Supply Voltage Booster to Increase the Maximum Achievable Attenuation Factor

If a 5V or higher supply voltage is available on-chip, than the charge-pump and the attenuator can be biased from this higher voltage allowing a much larger voltage headroom at the gate of the source follower transistor Mfol and thus a larger attenuation factor (A=3-5). This brings a capacitor reduction of 9-25 that is comparable and even may exceed the one that can be achieved with a Miller multiplied capacitor architecture. The advantage of the noise attenuator is that in addition to a relatively small on-chip loop filter capacitor it provides also a low phase noise output clock, while the Miller multiplication increases the phase noise at the output due to the excess noise coming from the Miller amplifier.

The charge-pump takes generally a very small current from the supply (few μA to few tens of μA). This is done to minimize the parasitic switching effects (clock feed-through and channel charge injection) of the charge-pump. The charge-pump current and the size of the switches are selected as low as possible for the given voltage headroom and oscillator control voltage range. On the other side, the minimum charge-pump current is limited by the switching speed of the two up and down currents. The longer the switching time, the larger the dead zone avoidance pulses necessary to ensure a dead-zone free operation and therefore the larger the reference spurs in the output clock spectrum.

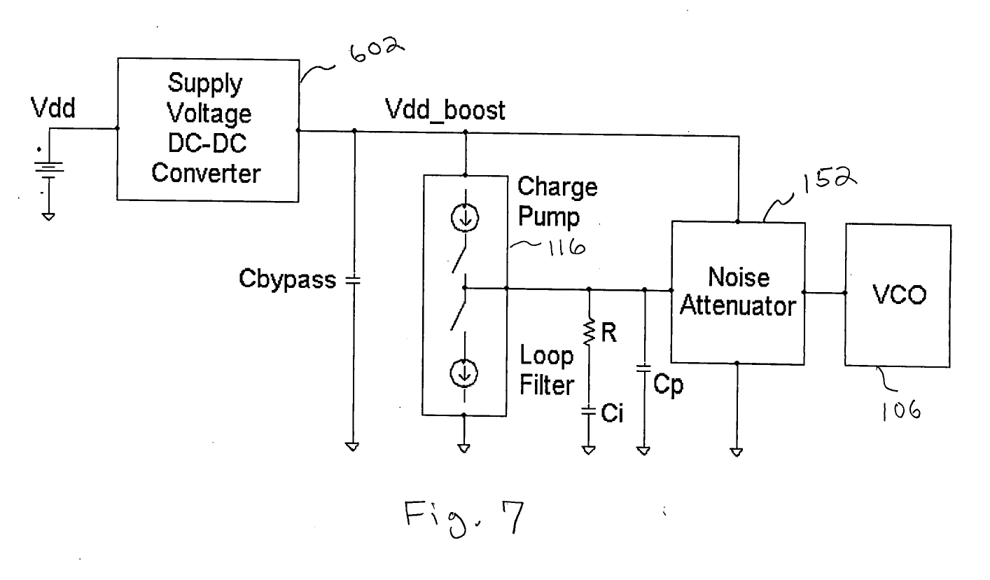

An alternative solution to the higher chip supply voltage that can help increase the attenuation factor in the loop filter divider is presented in FIG. 7. As shown in FIG. 7, the local supply voltage of the charge-pump is boosted using a voltage charge-pump converter 602. As the charge-pump current is so small and it is on only for a very short period of time, the discharge of the supply capacitor that holds the boosted voltage is negligible during each update period, and thus the modulation of the charge-pump supply at the update frequency is very small. This leads to a reasonably high PSRR and thus good reference spurs rejection performance. In the case of differential charge pumps, they take a continuous (DC) current from the supply. It needs to be small in order to limit the ripple on the supply line.

The charge-pump constituent devices do not see the entire supply voltage. Therefore the local supply to the charge-pump can be easily boosted to 4 or even 5V without having any device voltage breakdown issue. The limiting factor in this case would be the triode mode operation of the source follower. A regular threshold voltage device can be used in this case, avoiding usage of native FETs that may not be available in standard CMOS processes.

Using the charge-pump supply voltage boosting an attenuation factor of 3 or even 4 can be achieved in the loop filter noise attenuator, providing an on-chip capacitor reduction comparable with the one given by the Miller multiplication technique, but with a much smaller output clock jitter.

If the loop filter is the dominant noise contributor and the oscillator comes only in the second place, the maximum control voltage for the VCO can be slightly reduced from 1.3V to around 1V leading to a corresponding reduction of the oscillation amplitude. This will increase slightly the oscillator phase noise, but will allow a larger attenuation factor with the same supply voltage value, and thus will reduce the total output phase noise.

To keep the noise contribution of the attenuator low a much larger current (few mA) may need to be used. Therefore it might not be possible to bias the attenuator from a charge-pump based supply voltage boosting circuit (the supply voltage ripple due to the discharge of the capacitor Cbypass is too large). If only the charge-pump is biased from a larger supply (5V) and the attenuator is biased from the chip 10 supply (3.3V) the bottleneck for the attenuation factor increase is the triode region of the source follower circuit.

f. Transconductance Based Divider Attenuators

Previous sections have presented resistive type attenuators (polysilicon resistors) using a source follower as isolation element. A potential drawback of these attenuators is that the VGS voltage of the isolation source follower reduces the voltage headroom at the output of the charge-pump, limiting the maximum achievable value for the attenuation factor. The VGS voltage does not generally limit the attenuation factor value in the case of native devices with a zero or an almost zero threshold voltage.

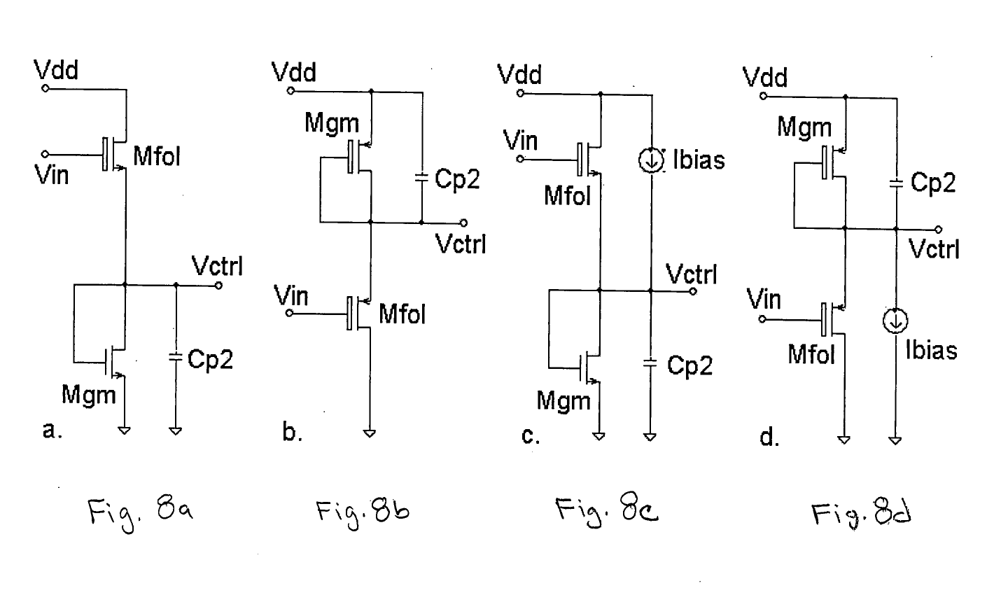

FIG. 8a presents an alternative circuit for realizing a source follower attenuator using transconductance based dividers that use the VGS voltage of the devices as part of the useful input and output voltages. The bulk of the source follower transistor Mfol was connected to the source in order to eliminate the body effect and thus avoid the parasitic coupling of the substrate noise into the signal path.

The gain of the circuit (inverse of the attenuation factor) is given by:

$$G = \frac{1}{At} = \frac{{g}_{m} ( Mdiod )}{{g}_{m} ( Mfol ) + {g}_{m} ( Mdiod )} \qquad ( 15 )$$

Depending on the range of the control voltage required by a given oscillator to cover the imposed output frequency range, the diode connected device (Mgm) can be a thin-oxide NFET (for Vctrl(min)<0.6-0.7V) or a thick-oxide NFET (for Vctrl(Min)>0.7-0.8V).

To minimize the noise contribution of both Mfol and Mgm devices, large area FETs are used. Also, in order to reduce the thermal noise of the two devices, low value W/L ratios are used such that the corresponding transconductance has a low value.

Using a native device with a zero threshold voltage (Vth=0) for transistor Mfol leads to a significant improvement of the voltage range at the output of the charge-pump, maximizing the value of the attenuation factor.

In this implementation the constant (offset) component of the oscillator control voltage is generated by the Vth threshold voltage of the diode Mgm device, being constant with the drain current variation. In contrast, the variable component of the oscillator control voltage is generated by the Vₒₙ=sqrt(2·I_{D}·L/μ·Cₒₓ·W) overdrive voltage of the diode connected device (in the case of a square law MOSFET device).

If the same type of device is used for both Mfol and Mgm, a process and temperature independent attenuation factor is obtained due to the close matching and tracking of the two transconductances.

FIG. 8b shows a complementary version of the attenuator from FIG. 8a using PFET devices, that gives a supply voltage referenced control voltage for the oscillator.

The DC current through the two devices is the same. To achieve a large attenuation factor (A), the two transconductances need to differ by the “A” factor, and as a consequence the W/L ratios need to differ by A² times. The minimum size of the source follower device is limited by the 1/f noise, leading to a very large area for the diode connected device.

An additional DC bias current Ibias can be injected in the Mgm device only as shown in FIG. 8c. This will decouple the DC currents through the two devices, allowing a much lower area for the Mgm device. FIG. 8d illustrates a complementary version of the attenuator from FIG. 8c using PFET devices.

One additional advantage of the transconductance based divider is that it can be implemented also in processes that do not provide polysilicon resistors, as is the case for the standard digital CMOS processes.

g. Common Source Attenuation Stages Using Resistors or Transconductances

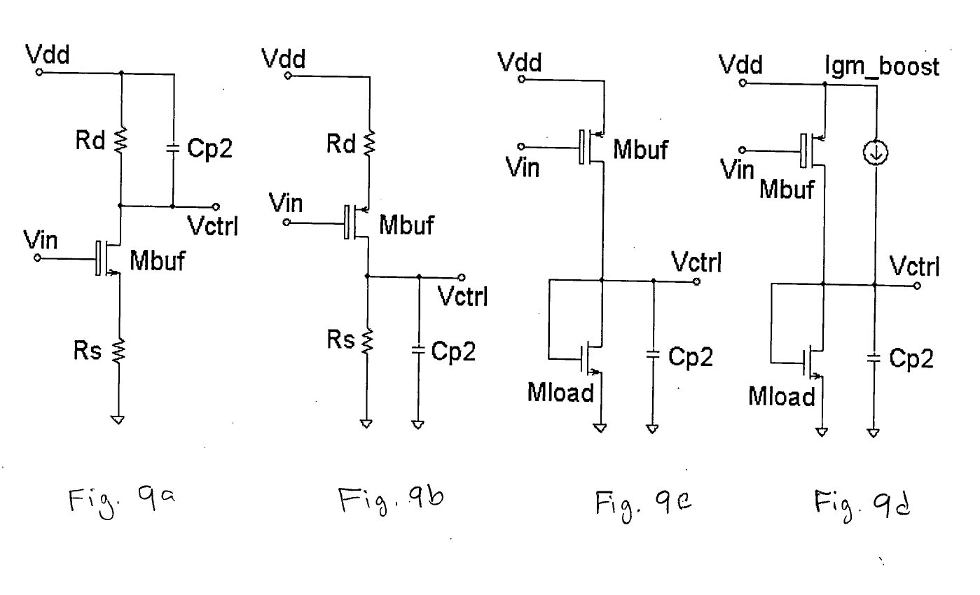

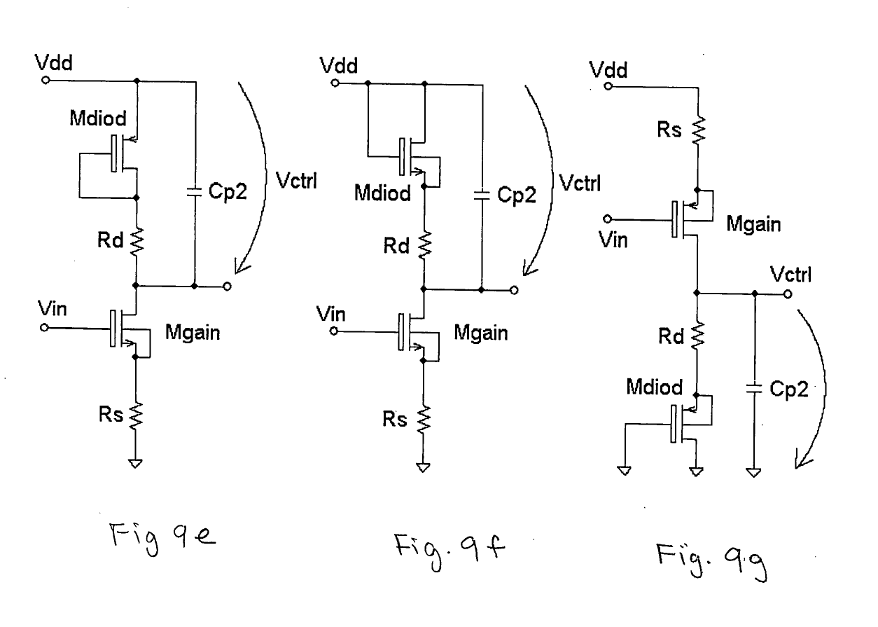

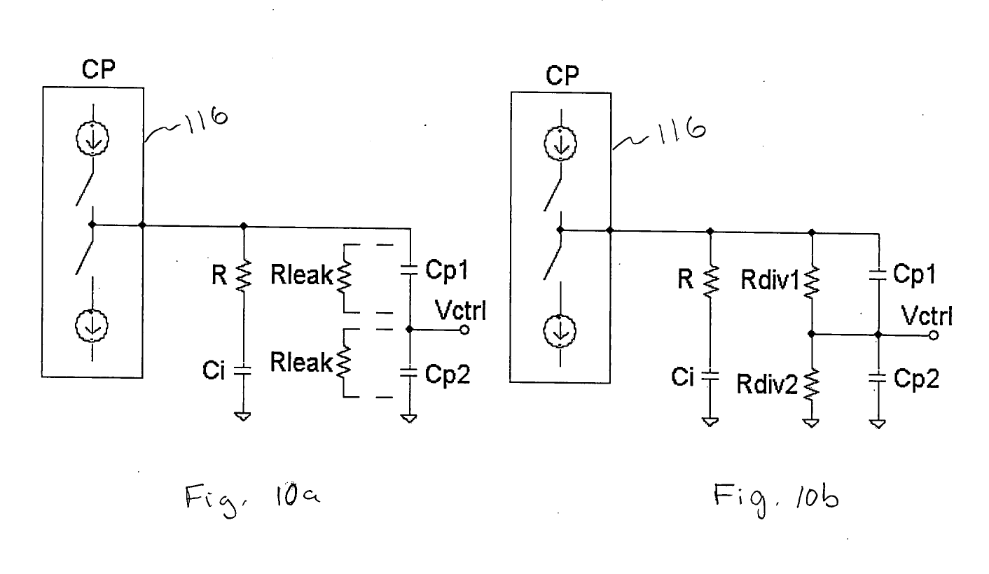

Yet another embodiment for realizing an active attenuator is to use a common source MOSFET (or common emitter BJT) with resistive load both in the source (emitter) and drain (collector). FIG. 9a shows a first embodiment of the common source attenuator that provides a supply referenced control voltage to the oscillator. As shown in FIG. 9a, a common source transistor Mbuf is coupled to a source resistor Rs and a drain resistor Rd.

The gain of the stage is given by the ratio of the two resistors:

$$G = \frac{1}{A} = - \frac{{R}_{d}}{{R}_{S} + \frac{1}{{g}_{m} ( Mgain )}} \approx - \frac{{R}_{d}}{{R}_{S}} \qquad ( 16 )$$

The resistor Rd is selected smaller than the resistor Rs, such that the gain results smaller than unity (attenuation). The capacitor Cp2 in conjunction with the reisistor Rd gives a second ripple pole that filters the high frequency noise. The noise of the Mbuf device (both thermal and 1/f noise) is well degenerated by the high value resistor Rs. The noise contribution of the attenuator is dominated by the noise coming from the output resistor Rd.

FIG. 9b shows a complementary version of the attenuator from FIG. 9a, that uses a PFET common source configuration and provides a ground referenced control voltage to the oscillator.

The Mbuf devices (both in the NFET and PFET cases) may be desirable to be thick oxide devices that can withstand a large gate-source voltage (2-3V). Their drawback is a relatively large threshold voltage (Vth=0.7V) that seriously reduces the maximum achievable attenuation factor due to the reduced voltage headroom at the output of the charge-pump. The zero-Vt transistor does not increase the headroom of the charge-pump output due to being in the triode region when the Vgd voltage goes over 0V=Vth.

The reason for the reduced attenuation factor is the fact that the VGS voltages of the active devices are not part of the useful input and output voltages.

FIG. 9c shows an alternative way of building the common source attenuator that uses the intrinsic transconductances of the devices Mbuf and Mload as an impedance divider. The gain of the stage is:

$$G = - \frac{gm ( Mgain )}{gm ( Mload )} \qquad ( 16 )$$

The electrons have a mobility about 2.5 to 3 times larger than the one of the holes. Therefore the transconductance of a NFET results with sqrt(2.5) to sqrt(3) times higher than the one of a PFET having the same size. The device sizes can also be used to set the ratio of the two transconductances, and thus the gain of the stage:

$$G = \sqrt{\frac{μ p}{μ n} \cdot \frac{Wp}{Lp} \cdot \frac{L n}{Wn}} \qquad ( 17 )$$

The advantage of this architecture is that the VGS of the common source device is directly equal to the input voltage, while the VGS voltage of the diode connected device is equal to the output voltage. The threshold voltage gives the necessary DC level shift of the oscillator control voltage. This reduces the headroom constraints at the charge-pump output, allowing a higher attenuation factor within a given supply voltage budget.

The area (W*L) of both the NFET and PFET devices should generally be large enough, such that their 1/f noise is negligible. Also the W/L ratio of Mbuf should be low and the ratio of Mload should be high, such that the thermal noise is kept at low levels.

One advantage of the transconductance ratio based attenuator is that it does not use polysilicon resistors and therefore can be implemented also in standard digital CMOS processes.

The high input impedance of the gate of Mbuf device ensures a negligible leakage current to the loop filter, avoiding the reference spurs degradation, as is the case in the direct coupling of the resistor divider to the loop filter.

The bias current through the NFET and PFET devices is the same. Therefore achieving a large attenuation factor requires a very large difference between the W/L of the two devices. The minimum area of the gain device is limited by the 1/f noise constraint, which leads to a very large area for the load device, increasing the size of the attenuator.

FIG. 9d gives an enhanced version of the attenuator in which an additional bias current Igm_boost is injected in the diode connected device to lower its equivalent impedance (1/gm). Thus the DC currents of the two devices are decoupled, allowing a separate optimization of their area. This leads to a significant reduction of the area required by the attenuator.

In the previously presented common-source attenuators (FIGS. 9a through b) the output voltage was generated by an IR voltage drop creating headroom issues. The main drawback of transconductance only approaches is the wide range variation of the supply current (FIGS. 9c and 9d). Generally the VCO control voltage range has a large offset voltage from zero (it is of the type Voff to Voff+ΔV). For many oscillators the control voltage that sets the frequency also gives the amplitude of oscillation. So to maintain a low phase noise, the amplitude needs to be large which result in a large control voltage. Generating the offset component of the control voltage Voff with an IR voltage drop leads to a much larger current I (the resistor R value is limited by the noise specification of the attenuator).

A much more power efficient way of generating the Voff voltage is to use a diode connected device that gives a Vth offset voltage starting from rather low values of the current through the device. FIG. 9e illustrates the use of such diode Mdiod in such a manner. FIG. 9e presents a common source attenuator that uses as load a series combination between a resistor and a diode connected device.

FIG. 9f shows an alternative way of realizing the common source attenuator with diode voltage shift, that uses the same type of device both for the gain and the DC level shift device. The bulk of devices Mdoide and Mgain are connected to their source in order to avoid the body effect, that otherwise may couple the substrate noise into the signal path. The transconductance of the two devices and also the two resistors track very well over process and temperature, providing a process and temperature independent attenuation factor:

$$G = \frac{1}{A} = \frac{Rd + \frac{1}{gm ( Mdiod )}}{Rs + \frac{1}{gm ( Mgain )}} \qquad ( 18 )$$

FIG. 9g shows a complementary attenuator to the attenuator of FIG. 9f that provides a grounded referenced control voltage to the oscillator. The large value of the Rs resistor connected to the source of the Mgain device strongly degenerates both the thermal and 1/f noise contribution of the active device.

Using resistors to generate the variable portion of the oscillator control voltage and VGS voltages to generate the DC portion of the control voltage offers an optimum compromise between the power dissipation and the noise performance of the attenuator.

h. All-Pass Passive Capacitor Divider Attenuators

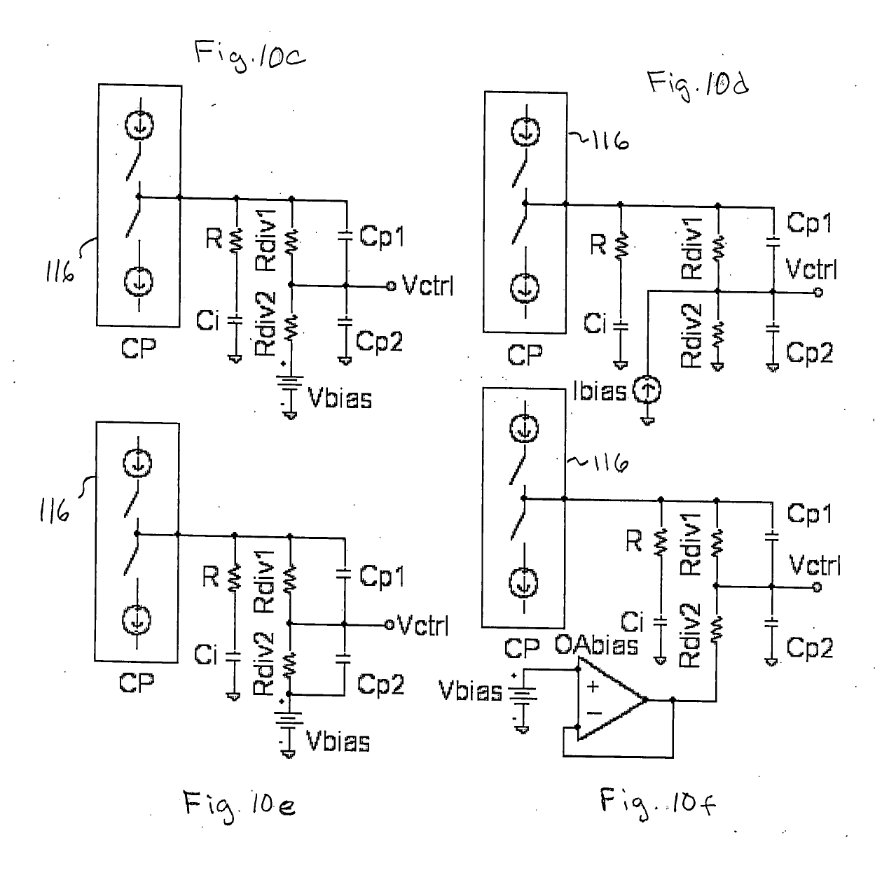

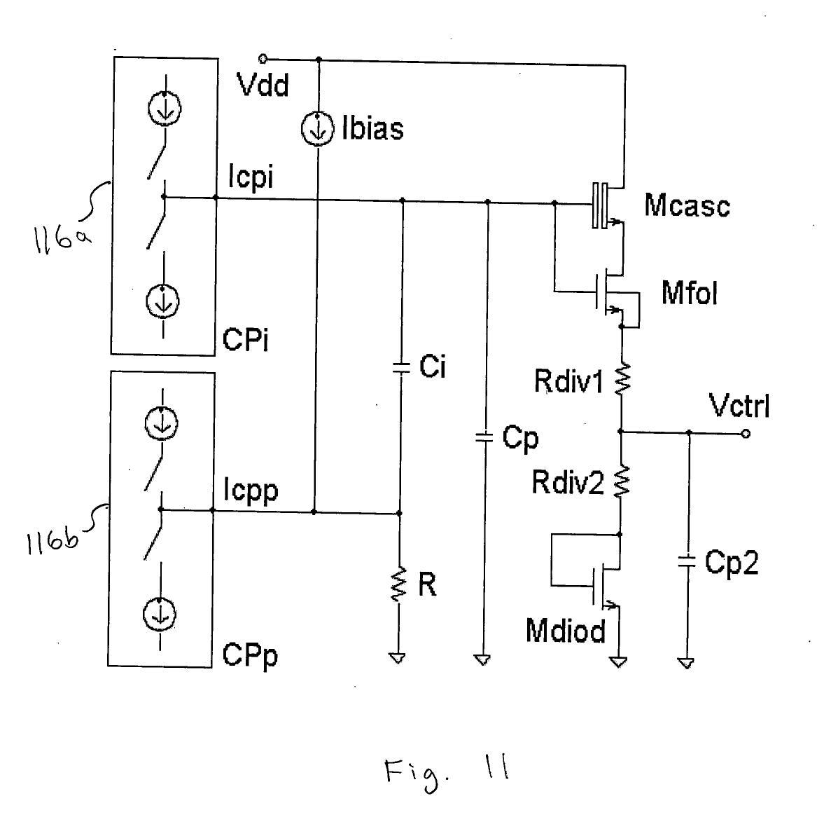

FIG. 10a presents another embodiment of the voltage attenuator that uses an all-pass capacitive divider instead of a resistor divider. The output voltage is generated by splitting the ripple pole capacitor Cp into two series connected capacitors: Cp1 and Cp2. The capacitors ensure the voltage division for the AC signals down to the frequencies comparable with the corner frequency given by the capacitor leakage equivalent resistors Rleak. To provide the correct voltage division for the DC signals and also for the very low frequency signals a very large value resistor divider having resistors Rdiv1 and Rdiv2 may be connected in parallel with the capacitor divider as shown in FIG. 10b. The resistor values should be high enough such that the leakage current through them does not impact the reference spurs performance of the PLL (integral capacitor discharge over the update period is negligible). The two division ratios of the capacitor and resistor dividers are selected to be equal:

$$G = \frac{1}{A} = \frac{\frac{1}{sCp 2}}{\frac{1}{sCp 1} + \frac{1}{sCp 2}} = \frac{Cp 1}{Cp 1 + Cp 2} = \frac{Rp 2}{Rp 1 + Rp 2} \qquad ( 19 )$$

The combined resistor and capacitor dividers connected in parallel constitutes an all-pass network that attenuates the oscillator control voltage with a fixed amount from DC up to high frequencies. If the relation Cp1*Rp1=Cp2*Rp2 is satisfied the attenuator has a frequency independent transfer function (it has a pair of coincident pole and zero that cancel each other) that does not impact the open loop transfer function of the PLL. In reality due to mismatches there will be a slight difference between the pole and the zero. To minimize its impact, the Rp1 and Rp2 resistors are selected with an enough high value that brings the pole and the zero lower than the PLL natural frequency. The capacitor values are selected based on the noise contribution from the RC all-pass divider. As the pole of the parallel RC configurations is significantly lower than the bandwidth of the PLL the total integrated noise caused by the Rp1 and Rp2 resistors is given by KT/C. Therefore a larger capacitor value will lead to smaller noise contribution from the attenuator.

The ripple pole for this all-pass RC attenuator passive loop filter is given by the series connection of the two capacitors in the attenuator:

$${f}_{p 2} = \frac{1}{2 π \cdot R \cdot \frac{{C}_{p 1} \cdot {C}_{p 2}}{{C}_{p 1} + {C}_{p 2}}} \qquad ( 20 )$$

This will result in an increase of the total capacitor used to bring a given ripple pole by a factor of A (the same as the voltage attenuation). However, the integral capacitance Ci that is much larger than Cp decreases by A², leading to a decrease of the total loop filter capacitance.

A second advantage of using the capacitor divider is that it achieves a very good PSRR as there are no devices in the loop filter that are connected to the supply line (as is the case for the source follower and resistor attenuator). Furthermore in the case of an all-pass RC network the limiting factor in the maximum achievable attenuation factor is only the voltage headroom at the output of the charge-pump. As the charge-pump takes a very small current (μA to tens of μA) it is easy to boost its supply voltage using a voltage charge-pump converter. Depending on the device breakdown voltage, supply voltages as high as 5-to-6V can be used leading to attenuation factors of 4 or even 5, and resulting into a 16-25 reduction of the loop filter integral capacitor (Ci).

As there is no DC current flowing in the main capacitor divider (the source follower and resistor attenuator take as much as 3-5 mA DC current), this solution is appropriate for portable applications where the current consumption of the PLL need to be minimized.

By splitting the ripple pole capacitance in two capacitors that have a ratio of “A”, while the ripple pole position needs to be conserved, the amount of ripple pole capacitance will increase by a factor “A”. However, this slight increase in ripple pole capacitance is completely offset by the large decrease (with an A² factor) of the much larger integral capacitance. For example in a standard RC filter design with a pole zero separation of 30 the total loop filter capacitance is 30C+C=31C. Using a noise attenuator RC loop filter with A=3, for the same output clock phase noise the integral capacitance is reduced by a factor of 9 and the ripple pole capacitance is increased by a factor of 3. The total loop filter capacitance is 30C/9+3C=6.3C which is about a factor 5 lower than the standard RC loop filter.

Using this very low noise all-pass RC divider in front of the large gain oscillator is equivalent from the noise and reference spurs analysis with an effective reduction of the oscillator gain, which is the prime factor of noise and reference spurs degradation in multi-GHz frequency synthesizers.

As was mentioned in the case of resistor divider attenuator, the oscillator control voltage range comes usually with a large offset voltage [Voff; Voff+ΔV]. This is necessary because in many oscillators the value of the control voltage is equal to the amplitude of the oscillation and maximizing the last one reduces the oscillator phase noise.

The all-pass RC divider from FIG. 10b has the drawback that the Voff and ΔV components of the control voltage are generated by the same IR voltage drop. Therefore the voltage range at the output of the charge-pump should be [A*Voff; A(Voff+ΔV)], where A is the attenuation factor. As the Voff voltage is large (0.5V or even higher) the A*Voff component dominates the headroom requirement. In a sense it wastes headroom as the Voff component does not contribute to the attenuation of the noise, but only introduces a voltage shift in the DC transfer characteristic.

This problem may be addressed by generating the Voff component of the output voltage with a voltage generator that is independent of the current through the resistor divider. In this way the voltage at the output of the charge-pump has a much lower absolute value [Voff; Voff+a*ΔV], reducing the headroom constraint and allowing a larger attenuation factor to be implemented.

The diode connected MOSFET solution used in the case of the pure resistor divider attenuator may not be viable in the case of the all-pass RC attenuator because the current through the resistor divider is very low in this last case (fractions of μA or lower in order to keep the discharge of the integral capacitor negligible and thus preserve a low reference spurs level). In this situation the MOSFET would operate in the deep sub-threshold regime, where its VGS voltage varies over a wide range with the drain current of the device. The Rdiv1 and Rdiv2 resistors have a very large value (MΩ or higher for negligible leakage) and they usually come with a large tolerance that widens the range of dispersion for the generated offset voltage.

FIGS. 10c-f present several embodiments of the offset voltage generators in the case of the all-pass RC attenuator. FIG. 10c shows the direct generation of the Voff offset voltage with the a DC voltage generator Vbias connected in series with the resistor Rdiv2. The noise of this generator appears in series with the noise of Rdiv2 that is generally much higher and dominates. The noise of the resistor divider together with the Vbias offset voltage generator is highly rejected by the low corner frequency RC time constant.

Although a complementary current-mode generation of the offset voltage can be implemented as shown with the current bias source Ibias in FIG. 10d, it is generally not desirable. There are two main drawbacks of this implementation: first a very low value current Ibias need to be generated (fractions of μA) that may come with a large tolerance and also may require substantial silicon area if it is obtained by mirroring down the global bias current (usually in tens of μA or few hundreds of μA range), and second the noise of the Ibias current generator is injected directly at the output.

FIG. 10e presents an alternative way of connecting the Cp2 capacitor, instead of going to ground it is connected together with Rdiv2 to the voltage generator Vbias. The difference between the embodiments of FIG. 10c and FIG. 10e is a slight change in the transfer function seen by the noise coming from the Vbias generator. Cp2 is much larger capacitance than Cp1 if an attenuation factor A>2 is implemented. If the Cp2 capacitor is implemented with a MOS capacitor than FIG. 10c may be a better choice since keeping one terminal of the capacitor grounded will reduce the impact of the large bottom plate parasitic capacitance to the substrate.

FIG. 10f presents one way of implementing the Vbias offset voltage generator using an operation amplifier OAbias as a buffer that ensures a low output impedance for the bias generator and thus an independence of the generated offset voltage on the DC current through the Rdiv1 and Rdiv2 resistor divider.

i. Passive Feed-Forward Loop Filter with Resistor Divider Noise Attenuator

To achieve an even larger reduction of the on-chip loop filter capacitor the noise attenuator can be coupled with a passive feed-forward RC loop filter as presented in FIG. 11. The main drawback of active feed-forward loop filters is the excess noise coming from the active devices used in the loop filter. A passive feed-forward loop filter can be obtained starting from a classical RC network filter (Ci integral capacitance, R stabilizing zero resistor and Cp ripple pole capacitor as shown in FIG. 11) to which two charge-pumps are attached: the integral charge pump (CPi) 116a that injects Icp_i into the series combination of Ci and R (as in the case of standard RC loop filter) and an additional proportional charge-pump (CPp) 116b that injects Icp_p directly into the series resistor R alone. The voltage developed on the resistor R is in series with the voltage on the Ci integral capacitance and therefore a passive summation of integral and proportional control voltages is realized without needing any active device amplifier. Injecting the proportional charge-pump current into the series resistor gives an effective multiplication of the resistor value from the stabilizing zero position point of view. The equivalent resistor is equal to the physical resistance R multiplied by one plus the ratio between the proportional and integral charge-pump currents:

$${R}_{eq} = R \cdot ( 1 + \frac{{I}_{cp\_p}}{{I}_{cp\_i}} ) \qquad ( 21 )$$

The stabilizing zero (ωz), the natural frequency (ωn), the ripple pole (ωp), the open loop zero-crossing frequency (ωc) and the damping factor (ξ) are given by the following equations:

$$\begin{matrix}{ω}_{z} = \frac{1}{R \cdot {C}_{i} \cdot ( 1 + \frac{Icp\_p}{Icp\_i} )} & ( 22 ) \\ {ω}_{n} = \sqrt{\frac{Kvco \cdot Icp\_i}{2 π \cdot N \cdot ( Ci + Cp )}} & ( 23 ) \\ {ω}_{p} = \frac{1}{R \cdot \frac{Ci \cdot Cp}{Ci + Cp}} & ( 24 ) \\ {ω}_{c} = \frac{{ω}_{n}^{2}}{{ω}_{z}} = \frac{Kvco \cdot R \cdot ( Icp\_p + Ico\_i )}{2 π \cdot N} & ( 25 ) \\ ξ = \frac{{ω}_{n}}{2 \cdot {ω}_{z}} = \frac{R \cdot ( 1 + \frac{Icp\_p}{Icp\_i} )}{2} \cdot \sqrt{\frac{Kvco \cdot Ci \cdot Icp\_i}{2 π \cdot N}} & ( 26 )\end{matrix}$$

where Kvco is the oscillator gain expressed in [rad/s·V], N is the feedback divider modulus and all the other terms have been defined previously.

When using the passive feed-forward loop filter having an output noise attenuator the capacitor reduction is given by the ratio between the two charge-pump currents multiplied by the square of the attenuation factor of the noise attenuator. The first one is limited for a given loop bandwidth by the voltage headroom at the output of the proportional charge-pump, while the second one is limited by the voltage headroom at the output of the integral charge-pump. Overall even in the case of wide frequency range PLL (that need a large range for the oscillator control voltage) the on-chip capacitance reduction is in excess of two orders of magnitude.

This ratio can be as large as 10-20 from the resistor multiplication to which an additional factor of 9-16 in loop filter capacitance reduction can be achieved by adding a noise attenuator with an attenuation factor of A=3-4 after the passive feed-forward RC loop filter. FIG. 11 shows the case when a source follower transistor Mfol is used to isolate the resistor divider from the passive RC loop filter. The combined reduction of the loop filter capacitance can be as large as 100-300 times, bringing on-chip capacitance from several nF down to few tens of pF. This will reduce the area of the loop filter capacitors and also minimize their parasitic capacitance to the substrate, with beneficial impact on the substrate injected noise rejection.

The passive feed-forward loop filter architecture leads to an increased value for the ripple-pole capacitance (for a given ripple pole position). However this increase is generally offset by the large reduction in the integral capacitance.

Using this passive feed-forward noise attenuator loop filter multi-GHz frequency synthesizers can be realized with sub-1psᵣₘₛ jitter. These low jitter PLLs have a wide variety of applications ranging from clocking high performance ADCs and DACs to frequency translation in modern communications systems.

In the previous paragraphs, different types of loop filter noise attenuators were described. Some of them use NFET, some use PFET and some both NFET and PFET devices. The scope of this invention is not limited to these above presented types of attenuators, but it apply to any other type of attenuator circuit that will bring the same advantage of reducing the size of the loop filter capacitor and reduce the loop filter and PLL front-end noise contribution.

Also the loop filter noise attenuation technique is not limited to the NMOS or CMOS technologies. It can be successfully applied in all the other available IC fabrication technologies including silicon bipolar (BJT), SiGe heterojunction transistor (HBT), MESFET, GaAs, etc, and also any combination of these technologies (e.g. BiCMOS).

Further modifications and alternative embodiments of this invention will be apparent to those skilled in the art in view of this description. The techniques disclosed herein may be utilized for a wide range of PLL configurations and are not meant to be limited to any particular PLL configuration. For example, one possible PLL configuration is disclosed in U.S. patent application Ser. No. ______, entitled “Method and Apparatus To Achieve a Process, Temperature and Divider Modulus Independent PLL Loop Bandwidth and Damping Factor Using Open-Loop Calibration Techniques” by Adrian Maxim and James Kao, filed concurrently with the present application, the disclosure which is expressly incorporated herein by reference. Accordingly, this description is to be construed as illustrative only and is for the purpose of teaching those skilled in the art the manner of carrying out the invention. It is to be understood that the forms of the invention herein shown and described are to be taken as presently preferred embodiments. Equivalent elements may be substituted for those illustrated and described herein and certain features of the invention may be utilized independently of the use of other features, all as would be apparent to one skilled in the art after having the benefit of this description of the invention.

What is claimed is:

1. A phase locked loop circuit, comprising:
a controllable oscillator providing an oscillator output;
a loop filter coupled within a loop path of the phase locked loop; and
an attenuator located within the loop path between at least a portion of the loop filter and an input of the controllable oscillator, the attenuator reducing phase noise in a clock provided at the oscillator output.

2. The phase locked loop circuit of claim 1, wherein the attenuator is a voltage attenuator.

3. The phase locked loop circuit of claim 1, wherein the attenuator is a current attenuator.

4. The phase locked loop circuit of claim 1, wherein the attenuator is a passive attenuator.

5. The phase locked loop circuit of claim 1, wherein the attenuator is an active attenuator.

6. The phase locked loop circuit of claim 1, wherein the attenuator comprises a resistor based voltage divider.

7. The phase locked loop circuit of claim 6, wherein the attenuator further comprises a capacitor coupled in parallel with at least one resistor of the resistor based voltage divider.

8. The phase locked loop circuit of claim 1, wherein the attenuator comprises a transistor based voltage divider.

9. The phase locked loop circuit of claim 1, wherein the attenuator comprises a capacitor divider and a resistor divider.

10. The phase locked loop circuit of claim 1, wherein the attenuator comprises a buffer stage at the input of the attenuator.

11. The phase locked loop circuit of claim 1, wherein the buffer stage comprises a transistor based buffer.

12. The phase locked loop circuit of claim 11, wherein the attenuator further comprises a voltage divider.

13. The phase locked loop circuit of claim 12, wherein the attenuator further comprises a diode.

14. The phase locked loop circuit of claim 11, wherein the transistor based buffer comprises a source follower transistor.

15. The phase locked loop circuit of claim 1, further comprising a boosted voltage supply coupled to the attenuator.

16. The phase locked loop circuit of claim 1, wherein the attenuator is formed within the loop filter.

17. A phase locked loop based frequency synthesizer for use in wideband tuner applications, comprising:
a controllable oscillator;
a loop filter; and
a voltage attenuator placed within a loop path of the phase locked loop and being between the controllable oscillator and at least a portion of the loop filter, the voltage attenuator comprising,
an input buffer; and
a voltage divider

18. The synthesizer of claim 17, wherein the voltage divider comprises a resistor divider.

19. The synthesizer of claim 18, wherein the voltage divider is a transconductance based divider.

20. The synthesizer of claim 19, wherein the input buffer and the transconductance based divider share at least one transistor.

21. The synthesizer of claim 17, wherein the input buffer comprises at least one transistor provided in a source follower configuration.

22. A method of integrating a frequency synthesizer circuit within an integrated circuit to provide a low phase noise output clock comprising:
providing a phase locked loop;
providing a controllable oscillator within the phase locked loop;
providing a loop filter within the phase locked loop, the loop filter including at least one loop filter capacitor within the integrated circuit;
attenuating a control input signal to the controllable oscillator sufficiently to allow for a smaller loop filter capacitor to be utilized as compared to the size that is required without such attenuation while still providing the same or better phase noise characteristics.

23. The method of claim 22, wherein the attenuation includes voltage attenuation and the method further comprises buffering an attenuator input signal.

24. The method of claim 23, wherein the buffering comprises utilizing at least one transistor in a source follower configuration.

25. The method of claim 23, further comprising providing an attenuation circuit block and providing either a regulated voltage supply or boosted voltage supply to the attenuation block.

26. The method of claim 22, wherein the attenuation is performed with a current attenuator.

27. The method of claim 22, wherein the attenuation is performed with a passive attenuator.

28. The method of claim 22, wherein the attenuation is performed with a active attenuator.
